(19) United States
(12) Patent Application Publication
(10) Pub. No.: US 2026/0253353 A1
(43) Pub. Date: Aug. 27, 2026

(54) FACIAL EXPRESSION SYSTEM FOR XR DEVICE WEARER FOR XR COMMUNICATION AND METHOD THEREFOR

(71) Applicant: Korea Advanced Institute of Science and Technology, Daejeon (KR)

(72) Inventors: Woontack WOO, Daejeon (KR); Seoyoung KANG, Daejeon (KR)

(73) Assignee: Korea Advanced Institute of Science and Technology, Daejeon (KR)

(21) Appl. No.: 19/532,166

(22) Filed: Feb. 6, 2026

(30) Foreign Application Priority Data
Feb. 11, 2025 (KR) 10-2025-0017044
Nov. 13, 2025 (KR) 10-2025-0171034

(51) Int. Cl. G06T 19/20; G06T 15/04; G06V 10/62; G06V 20/20; G06V 40/16

(52) U.S. Cl. CPC G06T 19/20; G06T 15/04; G06V 10/62; G06V 20/20; G06V 40/171; G06V 40/176; G06T 2219/2016; G06T 2219/2021

(57) ABSTRACT

The disclosure relates to a facial expression system for an XR device wearer and a method therefor, whereby it is possible to recognize the facial expressions of a user (or wearer) wearing an XR device in real time and reflects them in a 3D avatar face model, thereby enabling realistic and immersive communication in a virtual environment or remote collaboration environment, and more specifically, the system includes: a preprocessing module that detects landmarks from a user's face image and reconstructs a 3D avatar face model by optimizing facial shape and texture parameters based on the landmarks; and a real-time rendering module that estimates the user's pose parameters from the XR device worn by the user and applies blendshape-based expression and pose parameters to the 3D avatar face model, and performs rendering the result in real time.

### CROSS-REFERENCE TO RELATED APPLICATION(S)

This application claims priority under 35 U.S.C. 119 to Korean Patent Application No. 10-2025-0017044 filed on February 11, 2025, and Korean Patent Application No. 10-2025-0171034 filed on November 13, 2025 in the Korean Intellectual Property Office (KIPO), the entire contents of which are incorporated herein by reference.

### BACKGROUND OF THE INVENTION

### Field of Invention

The disclosure relates to a facial expression system for an XR device wearer and a method therefor, whereby it is possible to recognize the facial expressions of a user (or wearer) wearing an XR device in real time and reflects them in a 3D avatar face model, thereby enabling realistic and immersive communication in a virtual environment or remote collaboration environment.

### Description of Related Art

Recently, XR (Extended Reality)-based communication environments such as remote collaboration, virtual meetings, and metaverse are rapidly spreading. XR technology combines reality and virtuality to enable users to perform immersive interactions, thereby providing a communication experience similar to reality without physical distance constraints.

However, existing video conferencing systems and general 2D image-based communication technologies have difficulty accurately transmitting facial expressions or subtle emotional changes of users. In particular, when using a wearable device such as a head-mounted display (HMD) or XR glasses (hereinafter referred to as an "XR device"), a part of the upper portion (eyes, forehead, etc.) or the lower portion (mouth, chin, etc.) of the user's face is hidden by the device due to the structure of the device, which makes it difficult to directly capture or recognize with a camera.

To solve this problem, existing technologies mainly remain limited to simple estimation of facial expressions or restoration of facial expressions using only limited sensor information. Accordingly, since complex movements of the actual face (eyebrows, eyelids, mouth, chin, etc.) are not accurately reflected, there exists a limitation in that emotional transmission and immersion between users are reduced.

### BRIEF SUMMARY OF THE INVENTION

An object of the disclosure is to provide a facial expression system for XR communication and a method thereof that can accurately transmit a user's actual expressions and emotions in a virtual environment by tracking and analyzing a face of a user wearing an XR device in real time and naturally reflecting the same in a 3D avatar face model.

An object of the disclosure is to overcome the limitations of existing technology in which the accuracy of facial expression tracking is reduced by precisely restoring the entire facial expression of a user by simultaneously tracking movement of an occluded area and a non-occluded area using an infrared camera and an external tracking sensor built into the XR device.

An object of the disclosure is to improve the fidelity and realism of one's facial expression by reflecting the movement, gaze, and gesture of a user wearing an XR device in real-time estimated facial expression parameters and posture parameters so that a 3D avatar face model is synchronized with the user's actual facial expression.

An object of the disclosure is to standardize a human-to-3D avatar face modeling process from a user's face to a 3D avatar face, so that consistent facial expression is possible between various XR devices and platforms.

An object of the disclosure is to maximize the effectiveness of communication in various applications such as remote collaboration, education, medical care, and social XR by accurately reproducing facial expressions in an XR communication environment so that a user's emotions, gaze, and non-verbal gestures can be realistically transmitted.

However, the technical problems to be solved by the disclosure are not limited to the above problems, and may be variously expanded without departing from the technical spirit and scope of the disclosure.

A facial expression system of an XR device wearer for XR communication according to an embodiment of the disclosure includes: a preprocessing module that detects landmarks from a user's face image and reconstructs a 3D avatar face model by optimizing facial shape parameters and texture parameters based on the landmarks; and a real-time rendering module that estimates a user's posture parameters from an XR device worn by the user and applies blendshape-based expression parameters and the posture parameters to the 3D avatar face model, and performs rendering in real time.

The preprocessing module may include: an image input unit for receiving the face image, including monocular video or dynamic video; a landmark detection unit for extracting landmarks by detecting key facial features for each frame of the face image; a model fitting unit for optimizing the facial shape parameters based on the landmarks to restore an individual 3D facial shape; a texture filtering unit for correcting and filtering the texture parameters using 3D geometry information to reflect skin texture, brightness, and color tone to the 3D facial shape; and an optimization unit for reconstructing the 3D avatar face model by reflecting static and dynamic features according to changes in facial expression between frames of the face image to the 3D facial shape.

The real-time rendering module may include: a sensing unit that estimates the user's pose parameters and expression parameters using sensors built into the XR device and an external camera; an expression transformation unit that applies the expression parameters as weights of a blend shape to change landmarks of the 3D avatar face model in real time; and an avatar control unit that controls the 3D avatar face model in real time in response to the expressions and movements of the user wearing the XR device.

A method for expressing the face of an XR device wearer for XR communication performed by a computer device according to an embodiment of the disclosure includes: detecting landmarks from a user's face image and optimizing facial shape parameters and texture parameters based on the landmarks to reconstruct a 3D avatar face model; and estimating user's posture parameters from an XR device worn by the user and applying blendshape-based expression parameters and the posture parameters to the 3D avatar face model to render the model in real time.

The reconstructing may include: receiving the face image including a monocular video or a dynamic video; extracting landmarks by detecting key facial features for each frame of the face image; optimizing the facial shape parameters based on the landmarks to restore an individual 3D facial shape; correcting and filtering the texture parameters using 3D geometry information to reflect skin texture, brightness, and color tone to the 3D facial shape; and reconstructing the 3D avatar face model by reflecting static and dynamic features according to changes in facial expression between frames of the face image to the 3D facial shape.

The rendering in real time may include: estimating the user's pose parameters and expression parameters using sensors built into the XR device and an external camera; applying the expression parameters as weights of a blend shape to change landmarks of the 3D avatar face model in real time; and controlling the 3D avatar face model in real time in response to the expressions and movements of the user wearing the XR device.

According to an embodiment of the disclosure, since a user's face wearing the XR device can be accurately and realistically expressed, the user's non-verbal signals (eye movement, gaze, facial expression, etc.) and emotional transmission are improved, so that interaction in the XR environment can be more effective and natural.

According to an embodiment of the disclosure, it is possible to increase a user's immersion and participation through realistic facial expression restored in real time, thereby providing a communication experience similar to reality in various application environments such as virtual meetings, remote education, telemedicine, and social VR.

According to an embodiment of the disclosure, by providing a standardized face modeling and blendshape-based rendering method, consistent avatar face expression is possible between different XR devices or platforms, thereby providing the same and smooth user experience regardless of the type or manufacturer of XR glasses or HMD.

According to an embodiment of the disclosure, since human face capture, 3D avatar modeling, facial expression parameter extraction, and rendering processes are presented as a clearly defined comprehensive framework, developers, researchers, and industry stakeholders can easily apply standard technologies based on the disclosure, thereby promoting industrial dissemination and standardization of XR communication technology.

According to an embodiment of the disclosure, by realistically conveying a user's facial expression and emotion in an XR communication environment, it is possible to improve the quality of remote collaboration and social interaction, and contribute to enhancing the practicality and interoperability of XR technology.

However, the effects of the disclosure are not limited to the above effects, and may be variously expanded without departing from the technical spirit and scope of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram showing a detailed configuration of a facial expression system of an XR device wearer for XR communication according to an embodiment of the disclosure;

FIG. 2 is a block diagram illustrating a detailed configuration of a preprocessing module according to an embodiment of the disclosure;

FIG. 3 is a block diagram illustrating a detailed configuration of a real-time rendering module according to an embodiment of the disclosure;

FIG. 4 is an operation flowchart of a face expression method of a wearer of an XR device for XR communication according to an embodiment of the disclosure;

FIG. 5 shows a detailed operation flowchart of S410 according to an embodiment of the disclosure;

FIG. 6 shows a detailed operation flowchart of S420 according to an embodiment of the disclosure;

FIG. 7 is a schematic diagram showing a processing flow of a 3D avatar face model reconstruction step and a real-time face animation step according to an embodiment of the disclosure;

FIG. 8 is a diagram for explaining components of a pose parameter and an expression parameter in an occluded area and a non-occluded area according to an embodiment of the disclosure; and

FIG. 9A shows a sensor configuration diagram for facial expression sensing according to an embodiment of the disclosure, and FIG. 9B shows a mapping structure diagram of facial expression parameters and posture parameters sensed by FIG. 9A.

### DETAILED DESCRIPTION OF THE INVENTION

Hereinafter, preferred embodiments of the disclosure will be described in more detail with reference to the accompanying drawings. The same reference numerals are used for the same components in the drawings, and redundant descriptions of the same components are omitted.

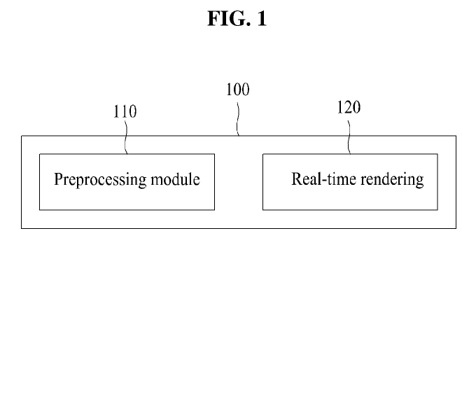

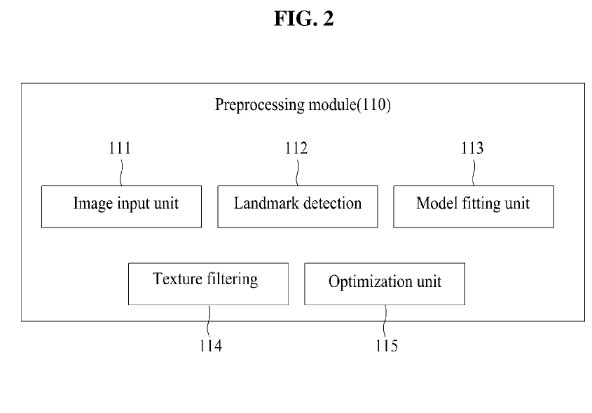

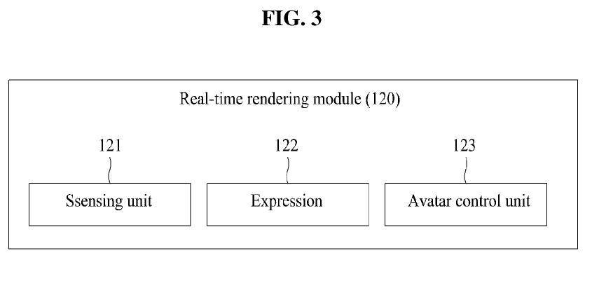

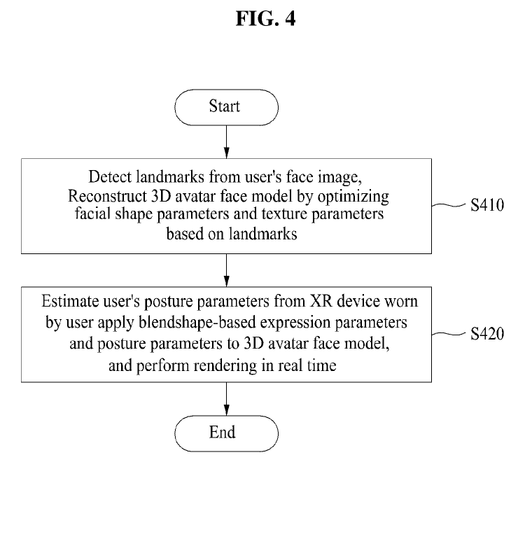

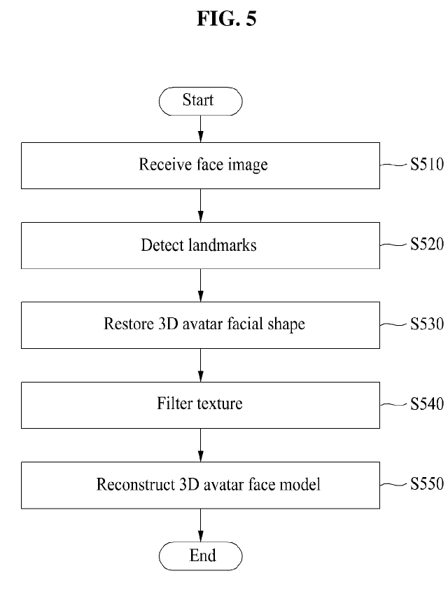

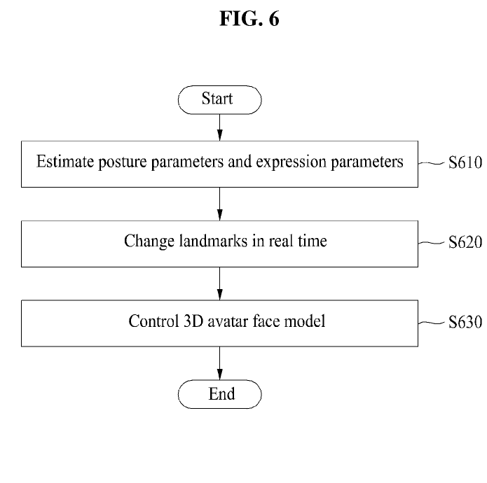

FIG. 1 is a block diagram showing a detailed configuration of a facial expression system of an XR device wearer for XR communication according to an embodiment of the disclosure, FIG. 2 is a block diagram illustrating a detailed configuration of a preprocessing module according to an embodiment of the disclosure, and FIG. 3 is a block diagram illustrating a detailed configuration of a real-time rendering module according to an embodiment of the disclosure. Furthermore, FIG. 4 is an operation flowchart of a face expression method of a wearer of an XR device for XR communication according to an embodiment of the disclosure, FIG. 5 shows a detailed operation flowchart of S410 according to an embodiment of the disclosure, and FIG. 6 shows a detailed operation flowchart of S420 according to an embodiment of the disclosure.

Each step (step S410 and step S420) shown in FIG. 4 is performed by the preprocessing module 110 and the real-time rendering module 120, which are the components shown in FIG. 1. Furthermore, each step (step S510 to step S550) shown in FIG. 5 is performed by the image input unit 111, the landmark detection unit 112, the model fitting unit 113, the texture filtering unit 114, and the optimization unit 115 of the preprocessing module 110, which are the components shown in FIG. 2, and each step (steps S610 to S630) shown in FIG. 6 is performed by the detection unit 121, the expression transformation unit 122, and the avatar control unit 123 of the real-time rendering module 120, which are the components shown in FIG. 3.

The facial expression system 100 of an XR device wearer for XR communication according to an embodiment of the disclosure shown in FIG. 1 tracks and analyzes a face of a user wearing an XR device in real time and renders the face in real time on a 3D avatar face model.

Referring to FIGS. 1 and 4, in step S410, the preprocessing module 110 detects landmarks from a user's face image, and reconstructs a 3D avatar face model by optimizing facial shape parameters and texture parameters based on the landmarks. Thereafter, in step S420, the real-time rendering module 120 estimates a user's posture parameter from an XR device worn by the user, and applies a blendshape-based expression parameter and posture parameter to the 3D avatar face model to render it in real time.

In step S410, the preprocessing module 110 performs an initial step of reconstructing a 3D avatar face model by capturing a human face to reconstruct the 3D avatar face model. In the initial step, the facial features of the user may be captured using a sensor of the XR device. In this case, the standard specifies the type (e.g., external camera, infrared sensor, depth sensor, etc.) and configuration of the sensor integrated into the XR device to effectively collect face data.

The preprocessing module 110 according to an embodiment of the disclosure performs a preprocessing function for reconstructing the face of a user wearing an XR device into a 3D avatar face model.

The preprocessing module 110 receives a user's actual face image and defines main parameters and features of face expression such as face geometry, surface texture, and expression markers, thereby generating a 3D avatar face model that accurately reflects the face shape and expression of each user. In this case, the generated 3D avatar face model is an avatar that represents the user wearing the XR device in a virtual space, and accurately captures and reconstructs the face geometry and appearance of a real person, so that an avatar face that is visually similar to the real person can be expressed.

To this end, the preprocessing module 110 detects facial landmarks such as eyes, nose, mouth, eyebrows, and facial contours from an input monocular or dynamic video face image, and restores a 3D face shape of each individual by optimizing a shape parameter β and a texture parameter δ of the face using each landmark. The preprocessing module 110 performs texture filtering using a 3D geometry map on the restored 3D facial shape, so that visual characteristics such as skin texture, color tone, and contrast are naturally expressed.

Accordingly, the preprocessing module 110 according to an embodiment of the disclosure integrates the geometric features and visual features extracted in this way to map essential facial expression elements of a real person to an avatar model, thereby defining expression modeling that can reflect facial expression changes or movements in real time.

In this specification, an XR device refers to a device for implementing extended reality (XR), and includes all types of devices that provide a user with visual, auditory, and tactile immersion by fusing real and virtual spaces, such as virtual reality (VR), augmented reality (AR), and mixed reality (MR). For example, the XR device may include XR glasses or a HMD (Head-Mounted Display) worn on the user's head, and is configured to track an entire user's face area in conjunction with sensors (e.g., camera, face tracking sensor, IR sensor, depth sensor, etc.) as needed.

In step S420, the real-time rendering module 120 performs facial data mapping and rendering as a real-time facial animation step. The facial data captured in step S410 is mapped to an avatar along with the user's facial geometry information and facial expressions through an algorithm. The processed data is then used to render the avatar's face in a virtual environment, and is synchronized with actual facial expressions and movements of the user in real time to provide a natural and realistic avatar expression.

The real-time rendering module 120 according to an embodiment of the disclosure recognizes movement and facial expressions of a user wearing an XR device in real time and reflects the movement and facial expressions in a 3D avatar face model generated by a preprocessing module 110, thereby implementing realistic and natural facial animation in an XR communication environment. The real-time rendering module 120 collects facial data from sensors and cameras built into the XR device, analyzes the collected data to estimate facial expression parameters (ψ) and pose parameters (θ), and transforms and renders the 3D avatar face model in real time based on these parameters.

Hereinafter, the preprocessing module 110 will be described in detail.

Referring to FIGS. 2 and 5, in step S510, an image input unit 111 receives a facial image including a monocular video or a dynamic video. More specifically, the image input unit 111 may receive a monocular video or a dynamic video obtained by photographing an actual face of a user. The input image, that is, the face image may be an image sequence photographed in a stationary human head state or a continuous frame image including facial expression changes.

According to an embodiment, the image input unit 111 may perform preprocessing to improve stability and fitting accuracy of face detection according to resolution, illuminance, photographing angle, background conditions, and the like of the input image.

In step S520, the landmark detection unit 112 extracts landmarks by detecting main feature points of the face for each frame of the face image. At this time, the detected landmarks are generally composed of position coordinates such as eyes, nose, mouth, eyebrows, and facial contour lines, and through this, geometric reference points of the face shape may be defined.

For example, the landmark detection unit 112 may extract landmarks for each frame of the face image by using a deep learning-based face keypoint detection model (CNN, HRNet, Mediapipe, etc.) or using an existing statistical model (Active Shape Model, Constrained Local Model, etc.).

In step S530, the model fitting unit 113 restores the 3D face shape of each individual by optimizing face shape parameters based on the landmarks.

The model fitting unit 113 may restore the user's unique 3D face shape by optimizing the 3D shape parameter β of the face by using the landmark information detected by the landmark detection unit 112. This may be performed by fitting the detected landmarks to a predefined facial basis model or a statistical 3D face model.

In step S540, the texture filtering unit 114 corrects and filters a texture parameter (δ) using 3D geometry information to reflect skin texture, contrast, and color tone in the 3D face shape.

The texture filtering unit 114 may naturally reproduce the texture, tone, contrast, and shading of the skin according to changes in lighting by using the 3D geometry information. In addition, the texture filtering unit 114 may include functions such as light source direction correction, color balancing, noise removal, and gamma correction for each area. The 3D avatar face model generated through this process may realistically express the skin texture and color of a real person.

Here, the 3D geometry information may represent information including spatial coordinate information for defining a 3D shape of a face, a surface normal vector, depth information, curvature, a mesh structure, and the like. Such information is basic data for mathematically expressing an actual shape of a face surface in a 3D space, and may be used in a process of calculating, correcting, and optimizing a shape parameter β and a texture parameter δ of a face model.

In step S550, the optimization unit 115 reconstructs the 3D avatar face model by reflecting the static and dynamic characteristics according to the expression change between frames of the face image in the 3D face shape.

More specifically, the optimization unit 115 may perform static and dynamic optimization to maintain temporal consistency between frames based on the face shape parameter β and the texture parameter δ calculated through each of the above-described steps. In addition, the optimization unit 115 may define an expression marker and form an expression modeling structure capable of mapping facial expression changes of a real person to a 3D avatar face model in real time.

Accordingly, the preprocessing module 110 may generate a standardized 3D avatar face model that may be used in an XR environment based on face data of an actual user.

Hereinafter, the real-time rendering module 120 will be described in detail.

Referring to FIGS. 3 and 6, in step S610, the sensing unit 121 estimates a pose parameter and an expression parameter of the user by using a sensor and an external camera built in the XR device.

The sensing unit 121 is configured to simultaneously sense the movement of the upper and lower areas of the user's face by using a sensor built in the XR device and a face tracking camera disposed outside the device. That is, the entire facial expression information may be estimated by separately collecting sensor data corresponding to each area by dividing the occluded area and the non-occluded area of the face and fusing them.

More specifically, the sensing unit 121 may sense the movement of the occluded area including the eye, eyebrow, and forehead of the user by using an infrared camera disposed inside the XR device. The internal infrared camera may stably sense eye movement, eyelid opening/closing, and detailed changes in the eyebrow without being affected by the lighting environment. In this case, the sensing unit 121 may extract posture parameters including eye roll, eye pitch, and eye yaw, and expression parameters of inner brow raiser, outer brow raiser and brow lowerer, and eye closure, eye widen and lid tighter from the occluded area.

In addition, the sensing unit 121 may sense the movement of the non-occluded area including the mouth, nose, and chin of the user by using a face tracking sensor disposed on the outer front of the XR device. The external sensor may be composed of an RGB camera, a depth camera, an infrared distance sensor, or the like, and may accurately capture the movement of the muscles of the lower face and the change in the shape of the lips. In this case, the sensing unit 121 may extract posture parameters including head roll, head pitch, and head yaw, and expression parameters including nose wrinkler, lip corner pull, lip corner depressor, lower lip depressor, lips part, jaw drop, lip suck, and lip tighten from the non-occluded area.

The sensing unit 121 according to an embodiment of the disclosure may calculate the overall face posture parameter θ_total and the overall expression parameter ψ_total by temporally synchronizing the extracted parameters of the occluded area and the parameters of the non-occluded area as described above.

Accordingly, by fusing heterogeneous data input from internal and external sensors of the XR device, the sensing unit 121 may accurately restore the user's overall expression even if some face areas are hidden when the XR device is worn, thereby improving the expression accuracy and realism of the 3D avatar face model.

In step S620, the expression transformation unit 122 changes the landmarks of the 3D avatar face model in real time by applying the expression parameter as a weight of the blendshape. Here, the expression parameter may be an overall expression parameter ψ_total calculated by the sensing unit 121.

The expression transformation unit 122 may apply the expression parameter ψ_total estimated by the sensing unit 121 to the 3D avatar face model to transform the shape of the avatar face in real time.

At this time, the expression transformation unit 122 uses a blendshape-based transformation method. That is, for a plurality of vertices and landmarks constituting the 3D avatar face model, the weight of each blendshape is made to correspond to the expression parameter ψ_total, and fine deformation of the face may be reflected in real time according to the corresponding weight value. Accordingly, the expression transformation unit 122 may apply the expression parameter as the weight of the blendshape in real time, thereby changing the vertex position of the 3D avatar face model in real time so that the user's expression change is naturally reflected on the avatar face.

In addition, the expression transformation unit 122 may preferentially process essential facial expression elements that directly affect communication quality even when the XR device is worn. For example, eye closure, inner/outer brow raiser, lip corner pull/depressor, and the like are regarded as key elements for nonverbal emotion transmission and are updated in real time on a frame-by-frame basis. On the other hand, detailed facial expression elements with low importance (e.g., jaw fine adjustment, cheek movement, etc.) may be processed in a weight quantization form or by adjusting the update cycle to minimize the overall computational load.

In this way, the expression transformation unit 122 may implement real-time efficient face animation by performing priority-based updating of the expression parameter ψ_total.

In step S630, the avatar control unit 123 controls the 3D avatar face model in real time in response to the expression and movement of the user wearing the XR device.

The avatar control unit 123 may integrally control the overall position, orientation, gaze, and the like of the avatar by applying the posture parameter θ estimated by the sensing unit 121 to the 3D avatar face model transformed by the expression transformation unit 122. Here, the posture parameter may be the overall posture parameter θ_total calculated by the sensing unit 121.

At this time, the posture parameter θ_total includes spatial movement information such as head roll, head pitch, and head yaw of the user, and the avatar control unit 123 may control the head direction and gaze of the avatar to be synchronized with the actual movement of the user by reflecting this in the head bone or transform matrix of the 3D avatar face model.

In addition, the avatar control unit 123 may control the user's facial expression change and head movement to be simultaneously reflected by synchronizing the facial expression parameter ψ_total transmitted from the facial expression transformation unit 122 and the posture parameter θ_total input from the sensing unit 121 in units of frames.

In addition, the avatar control unit 123 may manage a priority application order and a synchronization interval of the expression parameter (ψ_total) and the posture parameter (θ_total) during rendering to minimize latency or jitter and control to maintain a natural face-gaze integrated expression.

In addition, the avatar control unit 123 may dynamically adjust an update cycle and resolution according to a rendering environment or performance of the XR device. For example, in an environment in which hardware resources are limited, it is possible to provide a natural user experience while maintaining real-time performance by reducing an update frequency of gaze tracking and head rotation data and performing an update centered on facial expression parameters.

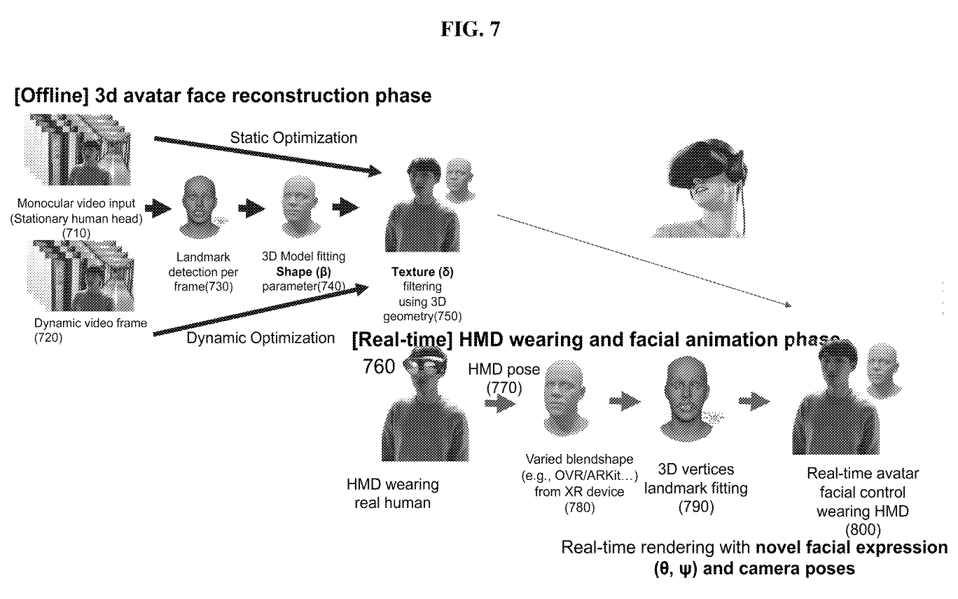

FIG. 7 is a schematic diagram showing a processing flow of a 3D avatar face model reconstruction step and a real-time face animation step according to an embodiment of the disclosure.

A facial expression system of a wearer of an XR device for XR communication according to an embodiment of the disclosure may be largely divided into a 3D avatar face model reconstruction step (step S410 in FIG. 4) and a real-time face animation step (step S420 in FIG. 4), and may be performed.

In the 3D avatar face model reconstruction step (offline step), the system of the disclosure receives a monocular video input 710 of a stationary user's face. At this time, a dynamic video frame 720 may be included, and a face image of the monocular video or the dynamic video frame may be used as original data for restoring an individual face shape.

The system of the disclosure detects key feature points such as eyes, nose, mouth, and contour for each frame of the input face image to detect landmarks required for 3D face model fitting (Landmark detection per frame, 730), and optimizes a face shape parameter (Shape parameter, β) based on the detected landmarks to restore a 3D face shape similar to the user's actual face (3D model fitting, 740). Thereafter, the system of the disclosure restores a texture parameter (Texture parameter, δ) using 3D geometry information (Texture filtering using 3D geometry, 750). In this step, visual characteristics such as skin texture, contrast, and color tone may be reflected in the 3D face shape.

In the real-time face animation step (real-time step), the system of the disclosure tracks the facial and head movements in real time while the user wears the XR device 760 of XR glasses or HMD. At this time, the system of the disclosure may estimate 770 a posture parameter (θ) including the user's head rotation, inclination, direction, and the like and a facial expression parameter (ψ) for the facial expression by using sensors (an external camera, an infrared sensor, a depth sensor, and the like) built in the XR device 760.

The system of the disclosure may transform 790 the expression of the 3D avatar face model in real time by applying 780 the facial expression parameter (ψ) estimated from the sensors (external camera, infrared sensor, depth sensor, etc.) built into the XR device 760 as the weight of the blendshape. Thereafter, the system of the disclosure may finally render 800 the 3D avatar face model by integrating the facial expression parameter (ψ) and the posture parameter (θ) in real time. Through this, even when the XR device is worn, the user's hidden face part is naturally restored and rendered on the 3D avatar face model, thereby enabling delivery of realistic expressions and emotions in a virtual environment.

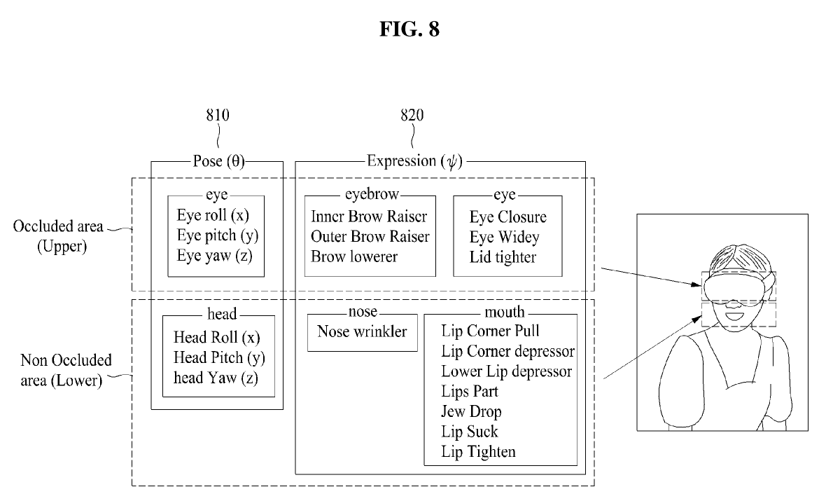

FIG. 8 is a diagram for explaining components of a pose parameter and an expression parameter in an occluded area and a non-occluded area according to an embodiment of the disclosure.

FIG. 8 illustrates components of the posture parameter (θ, 810) and the expression parameter (ψ, 820) based on an occluded area and a non-occluded area according to an embodiment of the disclosure.

Referring to FIG. 8, the upper part (eyes, forehead, etc.) of the face of a user wearing an XR device is occluded due to the structure of the device, and the lower part (mouth, chin, etc.) is exposed to the outside. Accordingly, the disclosure is configured to sense the user's facial expression data by using different sensors for each upper area and lower area, and to restore the entire facial expression by integrating the results.

Here, the occluded area tracks the movements of the eyes, eyebrows, and forehead using an internal infrared camera, and may calculate posture parameters 810 including eye roll, eye pitch, and eye yaw, and expression parameters 820 of inner brow raiser, outer brow raiser and brow lowerer, and eye closure, eye widen, and lid tighter.

In addition, the non-occluded area may detect movements of the mouth, nose, chin, etc. through an external face tracking sensor, and calculate posture parameters 810 including head roll, head pitch, and head yaw, and expression parameters 820 including nose wrinkler, lip corner pull, lip corner depressor, lower lip depressor, lips part, jaw drop, lip suck, and lip tighten.

As described above, the extracted parameters of the occluded area and the parameters of the non-occluded area are synchronized in time to generate the overall face posture parameter θ_total and the overall expression parameter ψ_total, and may be reflected in the vertex transformation and rendering of the 3D avatar face model.

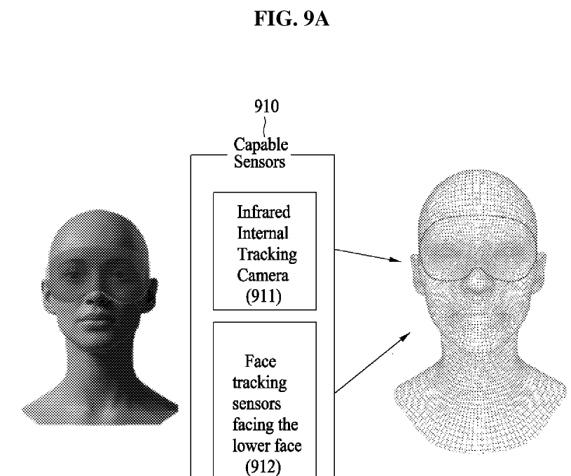

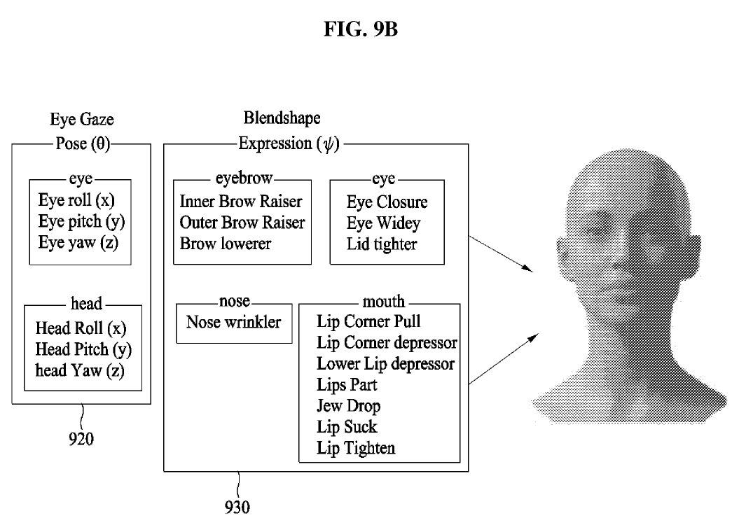

FIG. 9A shows a sensor configuration diagram for facial expression sensing according to an embodiment of the disclosure, and FIG. 9B shows a mapping structure diagram of facial expression parameters and posture parameters sensed by FIG. 9A.

Referring to FIG. 9A, the disclosure uses a sensor 910 for collecting facial expression data of an occluded area and a non-occluded area of a user wearing an XR device. In this case, the sensor 910 includes an infrared internal tracking camera 911 for detecting a facial expression for the occluded area and an external facial tracking sensor 912 for detecting a facial expression for the non-occluded region.

An infrared internal tracking camera 911 may be disposed inside the XR device to detect movements around the eyes and the upper face. This may stably capture fine movements of the pupil, eyelids, and forehead without being affected by the lighting environment.

An external face tracking sensor 912 is disposed on a lower external portion of the XR device to detect movements of the user's mouth, nose, and chin area. The sensor collects facial expression data in a non-occluded area and fuses it with data from the internal camera in real time to restore the user's overall facial expression.

Accordingly, the disclosure uses a sensor 910 including the infrared internal tracking camera 911 and the external face tracking sensor 912, thereby simultaneously securing sensing data of upper and lower faces to improve facial expression recognition accuracy.

A posture parameter 920 of FIG. 9B estimated using the sensor 910 of FIG. 9A corresponds to an eye gaze of an eye and a head pose, and an expression parameter 930 corresponds to a blendshape of an eyebrow, an eye, a nose, and a mouth.

The posture parameter 920 and the facial expression parameter 930 are extracted from the upper part (infrared internal camera, 911) or the lower part (external tracking sensor, 912) according to the position of the sensor 910 of FIG. 9A, and by fusing them, facial expression and posture information of the entire face may be consistently controlled.

According to the structure of FIG. 9B, the posture parameter 920 and the facial expression parameter 930 are independently calculated, but are integrated and applied in the stage of rendering to the 3D avatar face model, so that natural facial expression is possible in real time. Through this structure, the user's actual head movement and facial expression change are simultaneously reflected in the 3D avatar face model in the XR environment, so that natural and realistic communication is possible.

According to an embodiment of the disclosure, by reflecting the actual facial expressions and movements of a user wearing an XR device in real time, it is possible to improve the sense of immersion and social presence in a remote collaboration environment. Through this, interaction between users can be made more natural and participatory, thereby increasing the efficiency of communication and collaboration.

In addition, the system of the disclosure standardizes a blendshape structure and rendering method, whereby expression of an avatar face can be consistently maintained even on different XR platforms or applications, thereby reducing user confusion and securing interoperability.

Furthermore, it is possible to create a personalized avatar similar to an actual appearance based on a user's facial shape and texture, and adjust facial expression intensity or visual elements according to user preference, thereby increasing authenticity and satisfaction of virtual interaction.

The system or apparatus described above may be implemented as hardware components, software components, and/or a combination of hardware components and software components. For example, the apparatus and components described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. A processing device may execute an operating system (OS) and one or more software applications executed on the operating system. In addition, the processing device may access, store, manipulate, process, and generate data in response to execution of software. For ease of understanding, although a processing device may be described as being used singly, those skilled in the art will understand that the processing device may include a plurality of processing elements and/or a plurality of types of processing elements. For example, a processing device may include a plurality of processors or one processor and one controller. In addition, other processing configurations are also possible, such as a parallel processor.

As described above, although the embodiments have been described with reference to limited embodiments and drawings, various modifications and variations are possible for those skilled in the art from the above description. For example, appropriate results may be achieved even if the described techniques are performed in an order different from the described method, and/or components of the described system, structure, device, circuit, etc. are combined or combined in a form different from the described method, or are replaced or substituted by other components or equivalents.

Therefore, other implementations, other embodiments, and equivalents to the claims also fall within the scope of the claims described below.

What is claimed is:

1. A facial expression system of an XR device wearer for XR communication, comprising:
a preprocessing module that detects landmarks from a user's face image and reconstructs a 3D avatar face model by optimizing facial shape parameters and texture parameters based on the landmarks; and
a real-time rendering module that estimates a user's posture parameters from an XR device worn by the user and applies blendshape-based expression parameters and the posture parameters to the 3D avatar face model, and performs rendering in real time.

2. The facial expression system of claim 1,
wherein the preprocessing module comprises:
an image input unit for receiving the face image, including monocular video or dynamic video;
a landmark detection unit for extracting landmarks by detecting key facial features for each frame of the face image;
a model fitting unit for optimizing the facial shape parameters based on the landmarks to restore an individual 3D facial shape;
a texture filtering unit for correcting and filtering the texture parameters using 3D geometry information to reflect skin texture, brightness, and color tone to the 3D facial shape; and
an optimization unit for reconstructing the 3D avatar face model by reflecting static and dynamic features according to changes in facial expression between frames of the face image to the 3D facial shape.

3. The facial expression system of claim 1,
wherein the real-time rendering module comprises:
a sensing unit that estimates the user's pose parameters and expression parameters using sensors built into the XR device and an external camera;
an expression transformation unit that applies the expression parameters as weights of a blend shape to change landmarks of the 3D avatar face model in real time; and
an avatar control unit that controls the 3D avatar face model in real time in response to the expressions and movements of the user wearing the XR device.

4. The facial expression system of claim 3,
wherein the sensing unit
detects movement of an occluded area including the user's eyes, eyebrows, and forehead using an infrared tracking camera disposed inside the XR device, and detects movement of a non-occluded area including the user's mouth, nose, and chin using a facial tracking sensor disposed on the outer front surface of the XR device.

5. The facial expression system of claim 4,
wherein the movement sensing of the occluded area
extracts the posture parameters including eye roll, eye pitch, and left-right movement (eye yaw), and the facial expression parameters including eyebrow raise and lower (inner brow raiser, outer brow raiser, brow lowerer), and eyelid opening and closing (eye closure, eye widen, lid tighter), and
wherein the movement sensing of the non-occluded area
extracts the posture parameters including head roll, head pitch, and left-right movement (head yaw), and the facial expression parameters including nose wrinkle formation (nose wrinkler), lip corner movement (lip corner pull, lip corner depressor), and mouth opening and closing (lower lip depressor, lips part, jaw drop, lip suck, lip tighten).

6. The facial expression system of claim 3,
wherein the expression transformation unit
changes the vertex position of the 3D avatar face model in real time by applying the expression parameter as a weight of a predefined blend shape.

7. The facial expression system of claim 3,
wherein the avatar control unit
applies the pose parameters together with the 3D avatar face model transformed by the expression transformation unit, thereby controlling the rendering of the 3D avatar face model by integrating the entire position, direction, and gaze.

8. A method for expressing the face of an XR device wearer for XR communication performed by a computer device, the method comprising:
detecting landmarks from a user's face image and optimizing facial shape parameters and texture parameters based on the landmarks to reconstruct a 3D avatar face model; and
estimating user's posture parameters from an XR device worn by the user and applying blendshape-based expression parameters and the posture parameters to the 3D avatar face model to render the model in real time.

9. The method of claim 8,
wherein the reconstructing comprises:
receiving the face image including a monocular video or a dynamic video;
extracting landmarks by detecting key facial features for each frame of the face image;
optimizing the facial shape parameters based on the landmarks to restore an individual 3D facial shape;
correcting and filtering the texture parameters using 3D geometry information to reflect skin texture, brightness, and color tone to the 3D facial shape; and
reconstructing the 3D avatar face model by reflecting static and dynamic features according to changes in facial expression between frames of the face image to the 3D facial shape.

10. The method of claim 8,
wherein the rendering in real time comprises:
estimating the user's pose parameters and expression parameters using sensors built into the XR device and an external camera;
applying the expression parameters as weights of a blend shape to change landmarks of the 3D avatar face model in real time; and
controlling the 3D avatar face model in real time in response to the expressions and movements of the user wearing the XR device.
